(19) United States
(12) Patent Application Publication
(10) Pub. No.: US 2008/0008789 A1
(43) Pub. Date: Jan. 10, 2008

(54) Rolled food product that rolls up pieces of wholly granular food material and method of producing the same

(76) Inventor: Tatsumi Miyazaki, Gardena, CA (US)

Correspondence Address: J.C. Patents;SUITE 250, 4 VENTURE, IRVINE, CA, 92618, US

(21) Appl. No.: 11/786,974

(22) Filed: Apr. 13, 2007

Related U.S. Application Data
(60) Provisional application No. 60/819,952, filed on Jul. 10, 2006.

(51) Int. Cl. A23L 1/20; A23L 1/0526; A23L 1/36

(52) U.S. Cl. 426/96; 426/531; 426/629; 426/634

(57) ABSTRACT

A rolled food product that rolls up a plurality of pieces of a wholly granular food material is described, without falling-off of the wholly granular food material after being bit or cut. The rolled food product is characterized in that the pieces of the wholly granular food material therein are fixed as a stick by an edible sheet.

### CROSS-REFERENCE TO RELATED APPLICATION

This application claims the priority benefit of U.S.A. provisional application Ser. No. 60/819,952, filed on Jul. 10, 2006, all disclosure of the application is incorporated herein by reference.

### BACKGROUND OF THE INVENTION

1. Field of the Invention

This invention relates to a rolled food product that rolls up pieces of a wholly granular food material, and to a method of producing the same.

2. Description of the Related Art

Currently, certain rolled food products like sushi or roll cakes are produced by rolling up a layer of a food material together with, as an ingredient material, a plurality of pieces of a wholly granular food material like a bean. However, rolling up the food materials is troublesome even with hands, and it is very difficult to produce rolled food products with machines. Moreover, when a rolled food product is cut for eating or is sold as a cut product after the rolling, the pieces of the wholly granular food material at the biting or cutting section easily fall off after the rolled food product is bit or cut. For such a problem, the consumers are impressed that rolled food products are difficult to eat and handle, while disqualified products caused by falling-off of the wholly granular food material are obtained.

### SUMMARY OF THE INVENTION

### Issues to be Solved

Accordingly, this invention provides a rolled food product that rolls up a plurality of pieces of a wholly granular food material, which allows the rolling work to be easier to improve the production efficiency as well as prevents falling-off of the wholly granular food material after being bit or cut. This invention also provides a method of producing the same.

### Solutions for the Issues

After repeatedly studying the above issue, the Inventors can produce a rolled food product efficiently, without falling-off of the wholly granular food material, by wrapping and fixing pieces of the wholly granular food material as a stick by an edible sheet and then rolling up the same as an ingredient material in another food material. The wholly granular food material does not fall off even after the rolled food product is cut, so that a pretty cutting can be achieved. This invention is thus finished.

Specifically, this invention provides a rolled food product that rolls up a plurality of pieces of a wholly granular food material that is fixed as a stick by an edible sheet. The wholly granular food material may include a bean, a nut, a grain or a vegetable, wherein the bean may be young soybean. The edible sheet may include a soybean milk skin. In addition, the rolled food product may be one having been cut to show a cutting section thereof for eating, such as a sushi. This invention also provides a filling material applied to the rolled food product of this invention, which includes a plurality of pieces of a wholly granular food material that is fixed as a stick by an edible sheet. This invention also provides a method of producing a rolled food product, which includes a step of rolling up, in a food material, a stick of a plurality of pieces of a wholly granular food material that is wrapped and fixed by an edible sheet.

### EFFECT OF THE INVENTION

Because the plurality of pieces of the wholly granular food material as a stick is made into one piece in this invention, it is easy to handle in the rolling process of the rolled food product. Therefore, the efficiency in producing a rolled food product that rolls up pieces of a wholly granular food material can be enhanced. Moreover, since the wholly granular food material is fixed by an edible sheet, the wholly granular food material at the cutting section does not fall off piece by piece after the rolled food product is cut for eating. Moreover, it is possible to produce a rolled food product that shows a pretty cutting section of the wholly granular food material and thereby looks gorgeous even in the appearance.

It is to be understood that both the foregoing general description and the following detailed description are exemplary, and are intended to provide further explanation of the invention as claimed.

### BRIEF DESCRIPTION OF THE DRAWINGS

The patent or application file contains one drawing executed in color. Copies of this patent or patent application publication with the color drawing will be provided by the Office upon request and payment of the necessary fee.

FIG. 1 shows the photograph of a rolled sushi of Example 1 of this invention that was cut into round slices, wherein the granular food material showing cutting sections is young soybean and the edible sheet around the young soybean is a soybean milk skin.

### DESCRIPTION OF THE PREFERRED EMBODIMENTS

This invention will be specifically explained as follows. The rolled food product of this invention is characterized in rolling up, as an ingredient material, a plurality of pieces of a wholly granular food material that is fixed as a stick by an edible sheet.

### <Wholly Granular Food Material>

The wholly granular food materials used in this invention are not particularly limited, if only they are food materials that at least have a granular form not caused by a physical treatment like crushing, pulverization or cutting, etc. Because the size of one piece of the wholly granular food material has to exceed a certain level to avoid the falling-off issue, the grain size thereof is preferably 0.5 cm or more. Though the upper limit of the grain size is not limited, it is difficult to roll up a wholly granular food material having an overly large grain size in the rolled food product. Therefore, the grain size is usually not more than 2 cm. The scope of such food materials covers plant food materials like beans, grains, nuts, vegetables, fruits and so on, while the species thereof is not limited. Examples of the beans include soybean, young soybean, red bean, pinto bean, bush warbler bean, pea, fava bean and kidney bean, etc., wherein young soybean is preferred. One example of the grains is corn. Examples of the nuts include chestnut, ginkgo, walnut, sweet acorn, acorn, sunflower seed, peanut, almond, cashew nut, cocoa nut, pistachio, brazil nut, hazelnut, macadamia nut and pecan, etc. One example of the vegetables is pickled shallot. Examples of the fruits include prune, raisin, strawberry, blueberry, raspberry, cranberry, plum, kumquat, cherry, pomegranate, grape, acerola, olive and lychee, etc. An aforementioned food material can be directly used if it can be eaten raw, or can be used after being processed with a treatment suitable for food, such as roasting, boiling, steaming or frying, depending on the species thereof.

In this invention, a plurality of pieces of an aforementioned wholly granular food material is used, wherein the “plurality” means two or more. The number of the pieces used can be suitably determined according to the ratio of the size of one piece of the wholly granular food material to that of the rolled food product, while the preferred range thereof is 4-20.

### <Rolled Food Product>

The rolled food product of this invention is one rolling up a plurality of pieces of an above-mentioned wholly granular food material as an ingredient material. Though the shape of the rolled food product is not limited, the rolled food product is particularly preferably one that is cut before eating or during the production to show a cutting section thereof for eating. The ingredient materials of the rolled food product may further roll up food materials other than those mentioned above. Examples of the rolled food product include, sushi (rolled sushi) made by rolling up sushi rice as well as layer or a protein sheet, Chinese spring roll and roll cake, etc.

### <Edible Sheet>

The edible sheet in this invention is not particularly limited. For example, a soybean milk skin that is obtained by recovering the solidified layer formed at the liquid surface of heated soybean milk, layer, kelp, a vegetable leaf or an edible sheet formed from protein or starch as a raw material, etc., can be used, wherein the use of a soybean milk skin or a soybean protein sheet is preferred.

This invention is characterized in that the plurality of pieces of a wholly granular food material has been wrapped and fixed as a stick by an edible sheet before being rolled up in the ingredient material of the rolled food product, wherein the pieces of the wholly granular food material is preferably arranged into a row. Moreover, when the above stick is desired to be fixed more strongly after being wrapped by the edible sheet, a heating treatment like frying, steaming or roasting may be done. It is also possible to distribute the stick in a frozen state as a filling material for rolled food products. Moreover, a distributed product having been sterilized against various germs can be used as an instant food that only requires the user to defrost, and therefore is applied widely. By doing so, the plurality of pieces of the wholly granular food material can be rolled up as being firmly fixed in a certain shape. Hence, the work of rolling up the wholly granular food material in the rolled food product is very labor-saving and has a high efficiency. Moreover, after the rolled food product is cut, the pieces of wholly granular food material at the cutting section are prevented from falling off one by one. Since the wholly granular food material is firmly fixed by the edible sheet, the food material itself can be cut smoothly with a cutter or a knife, so that a pretty cutting section of the ingredient material is shown.

### EXAMPLES

An specific example of this invention is described as follows.

### Example 1

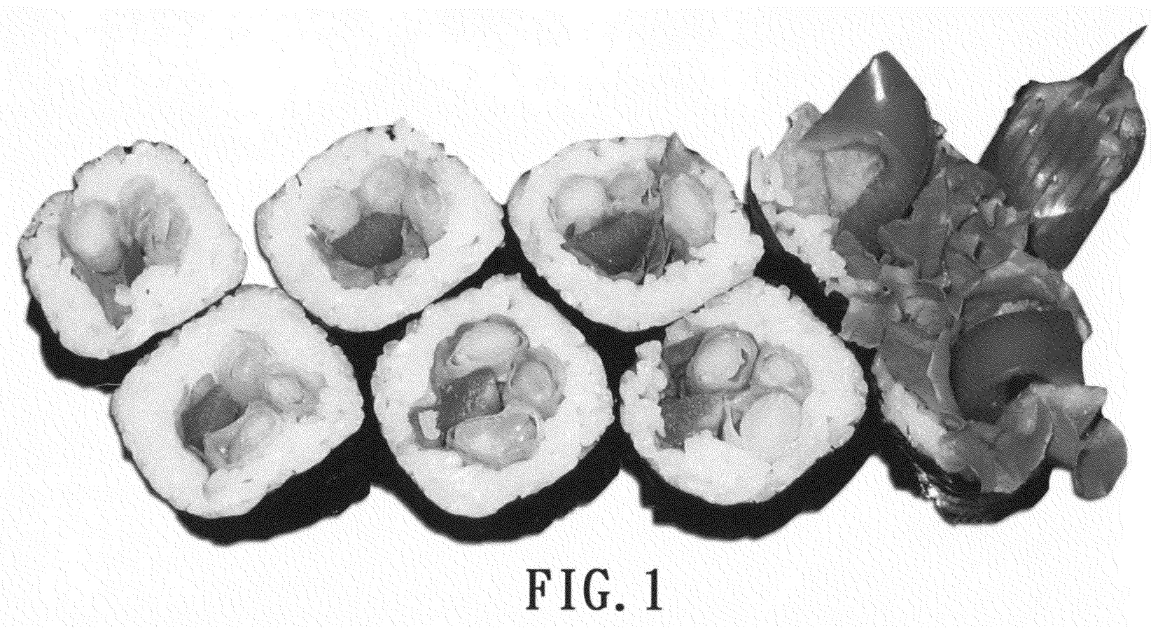

Ten pieces of boiled young soybean were arranged into one row on one edge of a soybean milk skin of 10 cm×10 cm in size, and the soybean milk skin was rolled up from one end thereof to make the ten pieces of young soybean into a stick. The wrapped stick was fried to fully fix the young soybean in the soybean milk skin and obtain a soybean milk skin-wrapped stick having a length of about 10 cm and a width of about 1 cm. Three pieces of the above soybean milk skin-wrapped stick together with sushi rice were put on a roasted layer sheet of 10 cm×20 cm, and the resulting composite was rolled up to form a rolled sushi having a length of about 10 cm and a diameter of about 6 cm. The obtained rolled sushi was cut into round slices of 3 cm thick of which the photograph is shown as FIG. 1, wherein some pieces of young soybean were cut into two parts respectively and pretty cutting sections were shown. Moreover, the pieces of young soybean at the cutting sections did not fall off, but were fixed firmly.

### Comparative Example 1

Thirty pieces of boiled young soybean together with sushi rice were put on a roasted layer sheet of 10 cm×20 cm, and the resulting composite was rolled up to form a rolled sushi. Accordingly, the young soybean in the rolled sushi was not fixed by a soybean milk skin as in Example 1. The obtained rolled sushi was cut into round slices of 3 cm thick, wherein some pieces of young soybean near the cutting sections fell off from the cutting sections so that pretty cutting sections were not obtained.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A rolled food product, which rolls up a plurality of pieces of a wholly granular food material that is fixed as a stick by an edible sheet.

2. The rolled food product of claim 1, wherein the wholly granular food material comprises a bean, a nut, a grain or a vegetable.

3. The rolled food product of claim 2, wherein the wholly granular food material comprises young soybean.

4. The rolled food product of claim 1, wherein the edible sheet comprises a soybean milk skin.

5. The rolled food product of claim 1, which has been cut to show a cutting section thereof for eating.

6. The rolled food product of claim 5, which is a sushi.

7. A filling material applied to the rolled food product of claim 1, comprising a plurality of pieces of a wholly granular food material that is fixed as a stick by an edible sheet.

8. A method of producing a rolled food product, comprising:
rolling up, in a food material, a stick of a plurality of pieces of a wholly granular food material wrapped and fixed by an edible sheet.
